(19) United States
(12) Patent Application Publication
(10) Pub. No.: US 2015/0120482 A1
(43) Pub. Date: Apr. 30, 2015

(54) Efficient Electronic Procurement Using Mathematical Optimization in an Electronic Marketplace

(71) Applicants: Elias Kourpas, Newark, DE (US); Nikolaos V. Sahinidis, Pittsburgh, PA (US)

(72) Inventors: Elias Kourpas, Newark, DE (US); Nikolaos V. Sahinidis, Pittsburgh, PA (US)

(21) Appl. No.: 14/527,037

(22) Filed: Oct. 29, 2014

Related U.S. Application Data
(60) Provisional application No. 61/896,953, filed on Oct. 29, 2013.

(51) Int. Cl. G06Q 30/06

(52) U.S. Cl. CPC G06Q 30/0605
USPC 705/26.2

(57) ABSTRACT

Embodiments are directed to electronic commerce and/or procurement in which buyers and suppliers are linked via an electronic marketplace in a cloud computing environment. Orders are placed by buyers to be executed and delivered by suppliers. An efficient electronic procurement network uses a mathematical optimization algorithm to minimize order costs while adhering to buyer requirements, optimization parameters, and supplier constraints. Suppliers input updated product information, as well as various constraints relating to the products, into the electronic marketplace to be used by the optimization algorithm. In some embodiments, multiple transaction options are provided to the buyer, with the multiple options determined by relaxing one or more of the buyer requirements and optimization parameters in the optimization algorithm.

### CROSS REFERENCE TO RELATED APPLICATIONS

This applications claims priority to U.S. provisional application Ser. No. 61/896,953 filed Oct. 29, 2013, which is incorporated herein by reference in its entirety.

### TECHNOLOGY FIELD

The present invention relates generally to electronic procurement, and more particularly to electronic procurement in which buyers and suppliers are linked to one another via an electronic marketplace.

### BACKGROUND

As the business world has become exceedingly interconnected, transactions between buyers and suppliers over networks of linked computers (e.g., the internet) have become commonplace. Electronic commerce, commonly known as e-commerce, refers to the selling of products and services over the internet and other computer networks. E-commerce is performed either by directly linking a buyer (or buyers) to a seller (point-to-point commerce) or by creating a virtual marketplace linking multiple buyers and sellers (electronic marketplace or e-marketplace). Transactions and commerce performed between individual consumers are classified as Consumer-to-Consumer (C2C); between businesses and individual consumers as Business-to-Consumer (B2C); and between businesses as Business-to-Business (B2B). There are many successful e-marketplaces that exist in the C2C and B2C space (e.g., eBay, Amazon.com) while some B2B general e-marketplaces have started to emerge (e.g., Alibaba).

The current paradigm of e-commerce through an e-marketplace involves the buyer searching for a specific product or service available from one or more sellers, comparing available options, and placing an order for that product or service at a specified price set by the seller (e.g., Amazon.com), or alternatively, placing a bid through an auction mechanism offered by the e-marketplace (e.g., eBay, Priceline). The process is repeated for each separate product or service the buyer wants to buy. While this paradigm has served buyers well in many e-marketplaces, it has several disadvantages. First, the process is more applicable to ordering “specific” products, i.e. specific products/brands, and less applicable to non-differentiated or slightly differentiated products (e.g., food) where the buyer is more concerned with certain product attributes (e.g., yellow cheddar cheese, organic, cubed) and quality (e.g., product rating) and less with the exact product, brand, or supplier. Second, the process is more targeted to purchasing small number of items; otherwise the search-and-compare procedure becomes very tedious as it has to be repeated multiple times. Third, the buyer cannot optimize (e.g., minimize the cost of) whole orders of multiple items that can be partially fulfilled by multiple suppliers but rather tries to minimize the cost of each individual item irrespective of total delivery cost, number of deliveries, or other buyer/supplier imposed constraints. Fourth, most e-marketplaces do not account for volume discounts and special pricing across multiple items, neither do they account for special pricing based on differentiated customer status. Finally, general e-marketplaces do not cater to the idiosyncrasies of specific industries, where different ordering mechanisms may be more applicable. For example, a restaurant chef responsible for procurement of food supplies may be more interested in ordering a collection of food ingredients that constitute a particular recipe in her/his menu, rather than having to order each ingredient separately.

In an effort to alleviate some of these disadvantages, e-procurement systems have typically avoided the creation of general marketplaces and have focused on directly linking specific suppliers with their customers via network connections (e.g., the Internet) and software interfaces (e.g., Electronic Data Interchanges, Application Programming Interfaces). While this paradigm has often served well in environments where buyers use single, or limited, source procurement for specific items (i.e., purchasing specific items from designated suppliers), the process becomes very restrictive when multiple suppliers exist, or dynamically emerge, that can supply the same items to the buyer. In such environments, the buyer ideally would like to have the option of switching between suppliers depending on price, quality, service, etc. The situation becomes even more cumbersome when typical orders include multiple items with fluctuating prices. Prices of food supplies, for example, constantly fluctuate in the marketplace. Therefore, a food service organization (e.g., restaurant, hotel, hospital, etc.) could greatly benefit from switching suppliers based on costs and splitting orders between suppliers in order to minimize total cost. To accomplish such objective, the buyer would need to link to multiple suppliers through different interfaces and have information technology (IT) knowledge and resources to do so.

A greater problem exists when buyers and suppliers impose different procurement requirements and constraints on the impending transaction. For example, the buyer may want products delivered within a certain timeframe, whereas suppliers may offer different delivery times. The buyer may also want to restrict the number of deliveries to her/his business establishment. At the same time, a supplier may not be willing to deliver an order unless it has met a minimum purchase level, sufficient to cover her/his delivery and other operating costs. In these cases, buyers would still be unable to optimize the whole order, just subsets of the order from different suppliers.

Thus, an improved B2B e-marketplace, linking together various buyers and various suppliers, while solving the numerous problems described above, is desired.

### SUMMARY

Embodiments of the present invention provide a system and a computer-implemented method for conducting efficient electronic commerce and/or procurement among a plurality of buyers and a plurality of suppliers using mathematical optimization. A network is configured to interconnect the buyers and the suppliers. The network is an efficient electronic procurement network (EePN) using cloud based software that minimizes order costs while adhering to buyer requirements, optimization parameters, and supplier constraints. The network includes one or more servers configured to: receive input from one of the plurality of buyers relating to a transaction; optimize the transaction among the one of the plurality of buyers and one or more of the plurality of suppliers according to one or more predefined buyer and supplier attributes, requirements and constraints; and convey results of the optimized transaction to the one of the plurality of buyers and the one or more of the plurality of suppliers involved in the optimized transaction. In an embodiment, the optimization process comprises defining the transaction as a dual problem and solving a sequence of dual problems corresponding to sub-problems of the transaction, the solution to which leads to a solution to the original problem.

The computer-implemented method comprises: formulating a mathematical optimization problem for a transaction among one of the plurality of buyers and one or more of the plurality of suppliers, the mathematical optimization problem comprised of an objective function and one or more variables comprised of one or more predefined buyer and supplier attributes, requirements and constraints; executing transaction optimization code that optimizes the objective function adhering to the one or more predefined buyer and supplier attributes, requirements and constraints, wherein results of the executed transaction optimization code yield one or more combinations of the one of the plurality of buyers and one or more of the plurality of suppliers; and conveying the optimized transaction results to each participant involved in the transaction.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 illustrates a typical e-procurement environment within an e-marketplace in which embodiments of the present invention can be practiced;

FIG. 2 shows an overview of typical means buyers and suppliers can use to access an EePN, according to embodiments described herein;

FIG. 3 shows a flowchart illustrating the steps a buyer follows to execute and optimize an order through an EePN, according to embodiments described herein;

FIG. 4 summarizes an exemplary embodiment of an EePN in the food distribution and procurement industry;

FIG. 5 illustrates a summary of ordering mechanisms available through an EePN, according to embodiments described herein;

FIG. 6 illustrates ordering items through a menu-guided taxonomy method in an EePN embodiment in the food distribution industry;

FIG. 7 illustrates ordering items through a specials and promotions method in an EePN embodiment in the food distribution industry;

FIG. 8 illustrates ordering items through a favorite items method in an EePN embodiment in the food distribution industry;

FIG. 9 illustrates ordering items through a favorite orders method in an EePN embodiment in the food distribution industry;

FIG. 10 illustrates ordering items through a logical grouping method in an EePN embodiment in the food distribution industry;

FIG. 11 illustrates a selection of buyer optimization parameters in an EePN embodiment in the food procurement industry;

FIG. 12 illustrates an example of developing a buyer designated supplier network in an EePN embodiment in the food procurement industry;

FIG. 13 illustrates an example of a seller review in an EePN embodiment in the food procurement industry;

FIG. 14 illustrates an EePN optimization process, according to embodiments provided herein;

FIG. 15 illustrates optimized order options in an EePN embodiment in the food procurement industry;

FIG. 16 shows a flowchart of steps performed in a mathematical optimization algorithm within an EePN, in accordance with embodiments provided herein;

FIG. 17 shows efficient advertising mechanisms available through an EePN;

FIG. 18 illustrates an example of a GUI for submitting company advertisements in an EePN embodiment in the food distribution industry;

FIG. 19 illustrates an example of a GUI for submitting specials and promotions in an EePN embodiment in the food distribution industry;

FIG. 20 illustrates an example of a GUI for submitting recipes in an EePN embodiment in the food distribution industry;

FIG. 21 illustrates an example of buyer invoices in an EePN embodiment in the food procurement industry;

FIG. 22 illustrates an example of expenses by supplier report in an EePN embodiment in the food procurement industry;

FIG. 23 illustrates an example of a product-price comparison report in an EePN embodiment in the food procurement industry; and

FIG. 24 illustrates an example of a territory sales report in an EePN embodiment in the food procurement industry.

### DETAILED DESCRIPTION

Embodiments of the present invention relate to electronic commerce (e-commerce) and electronic procurement (e-procurement) in which buyers and suppliers are linked via an electronic marketplace (e-marketplace). E-procurement may refer to the electronic procurement of indirect goods and services, including raw materials (e.g., food to be used in producing restaurant menu items) and may be considered a subset of e-commerce, which may refer to general electronic commerce (e.g., buying, selling, and trading) of any type of item (raw materials, final products, etc.). While embodiments herein may be described with reference to e-procurement, the invention is not limited to indirect goods, services, and raw materials generally associated with e-procurement but may instead be utilized with any type of item, service, and/or product generally associated with e-commerce.

Procurement orders are placed by buyers to be executed and delivered by suppliers (also referred to as sellers and distributors). In particular, embodiments are directed to the development of efficient electronic procurement networks using cloud computing based software (often referred to as Software as a Service “SaaS” based software) that minimizes order costs while adhering to buyer requirements, optimization parameters, and supplier constraints.

Embodiments are directed to the use of mathematical optimization algorithms that facilitate procurement between buyers and suppliers within an efficient electronic procurement network (EePN). EePNs are applicable to commercial transactions with particular market characteristics, such as but not limited to: (a) transactions include (but are not limited to) non-differentiated and slightly differentiated products, (b) typical orders comprise multiple items in various quantities, (c) frequent orders are submitted at regular intervals, (d) environments where cost optimization is a critical factor for buyers, (e) markets exhibiting price fluctuations, creating a higher need for optimization, (f) markets and industries where multiple suppliers exist that supply to current buyers (i.e., no single sourcing), (g) environments where suppliers face high logistical costs, (h) markets with high competition between buyers and between suppliers, and (i) markets where shortage of specialized IT skills restrict the adoption of differentiated e-procurement models offered by different vendors.

Examples of industries where such characteristics are prominent include, but are not limited to, distribution and procurement of food, medical supplies, construction and building supplies, and secondary financial markets. Though not all of the aforementioned characteristics need to be present, the higher the presence and intensity of those characteristics, generally the higher the need for such efficient e-procurement networks. While EePNs can be applicable to Consumer-to-Consumer (C2C) and Business-to-Consumer (B2C) marketplaces, they are primarily pertinent to Business-to-Business (B2B) markets.

Buyers operating in such markets attempt to minimize costs, while attending to quality of the products and services of the suppliers. Buyers have often developed relationships with multiple suppliers and have created their own network (including multiple distributors) to obtain the products necessary for their businesses. Buyers predominantly use the following modes to “optimize” their orders with their own network of suppliers:
Buyers compare product prices across suppliers manually or electronically.
Buyers often purchase a large volume of products from one supplier to obtain discounted prices taking advantage of volume discounts.
Buyers get discounted prices from one supplier according to their overall level of purchasing and also according to the size of their business (e.g., gold vs. platinum level discounts).
Buyers may opt to join purchasing programs (e.g., Avendra in food distribution), which involve the purchasing power of multiple businesses to get discounted prices on certain products (not necessarily all) from specific suppliers.

In accordance with embodiments of the present invention, an EePN facilitates electronic procurement between buyers and sellers allowing buyers to optimize their order (i.e., minimize costs) while taking into consideration:
Buyer profile and status with individual suppliers. Profile and status information includes, but is not limited to, geographic location, purchase history, size of business entity, preferential status with individual suppliers (e.g., platinum, gold, silver), membership with purchasing programs, credit classification, and other attributes.
Buyer requirements and constraints. Buyer can select optimization criteria and constraints available through the system. Such parameters may include delivery time, maximum number of deliveries, quality rating of products and suppliers, and designated subgroup of acceptable suppliers.
Supplier requirements and constraints. These include, but are not limited to, delivery time constraints, special pricing, volume discounts, and minimum delivery levels.

Exemplary embodiments provided herein are directed to a method and a system architecture for food service organizations in the food distribution and procurement industry. Food service organizations include restaurants, hotels, hospitals, government and military, schools and universities, and the like. Although embodiments herein are described with reference to the food distribution and procurement industry, the invention is not limited to this industry and may instead be applied to various other embodiments in which an optimized procurement of products and/or services is desired.

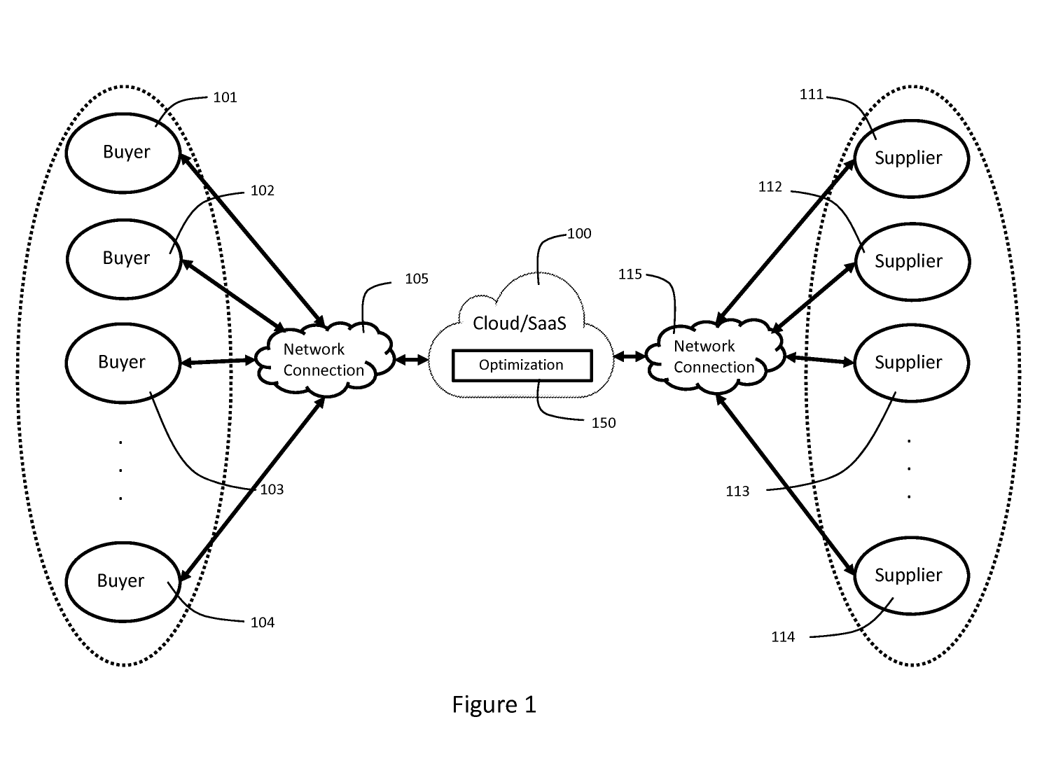

FIG. 1 illustrates an e-procurement environment within an e-marketplace in which embodiments of the current invention may be practiced. An EePN 100, deploying mathematical optimization algorithms, is coupled to a plurality of buyers 101, 102, 103, and 104 via a network connection 105 (e.g., the Internet). Similarly, the EePN 100 is connected to a plurality of suppliers 111, 112, 113, and 114 via a network connection 115. The EePN 100 may operate in a cloud computing (also referred to as Software as a Service (SaaS)) environment and may be comprised of a server or servers, processors, memory media, and computer optimization code (software) 150, and may also include one or more databases, a content management system (CMS), and other computer components and code necessary for storing and unitizing information for optimizing and executing procurement transactions according to various embodiments provided herein.

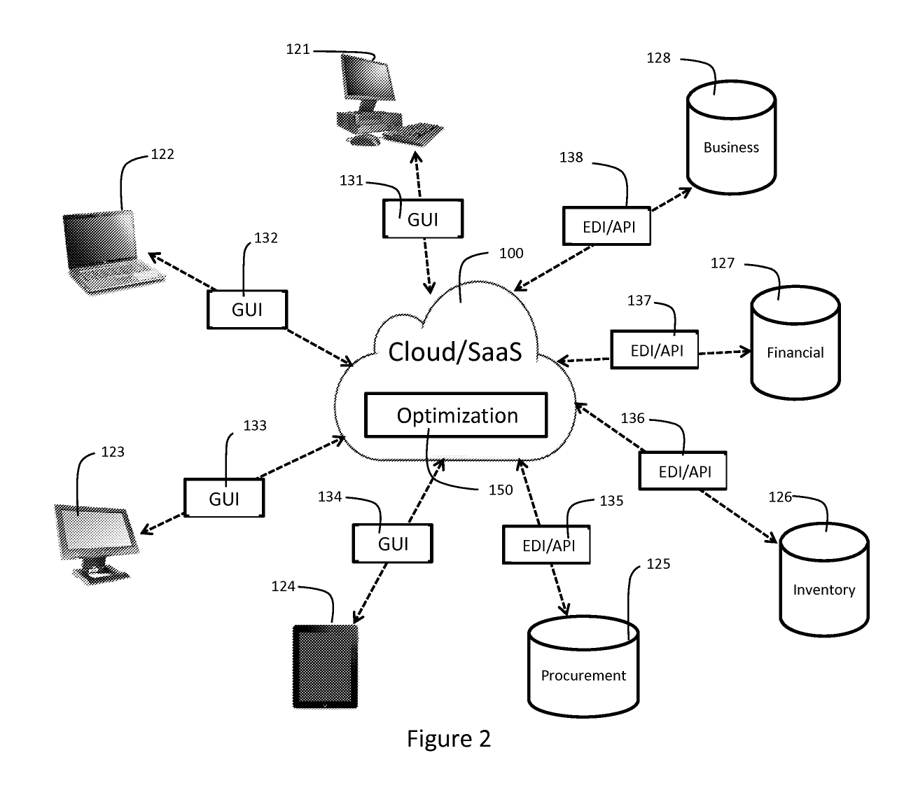

FIG. 2 provides an overview of typical means buyers and suppliers can use to access the EePN 100. These means include, but are not limited to, a traditional desktop 121 with a Graphical User Interface (GUI) 131, a notebook computer 122 with GUI 132, a terminal 123 with GUI 133, and a tablet or other mobile device 124 with GUI 134. Furthermore, information from a supplier (or buyer) can be communicated directly to and from the EePN 100 without human operator interaction through an Electronic Data Interchange (EDI) or other Application Programming Interface (API). For example, a procurement system 125, inventory system 126, financial system 127, or other business system 128 can communicate with the EePN 100 and its embedded optimization software 150 through the use of corresponding EDIs/APIs 135, 136, 137, and 138.

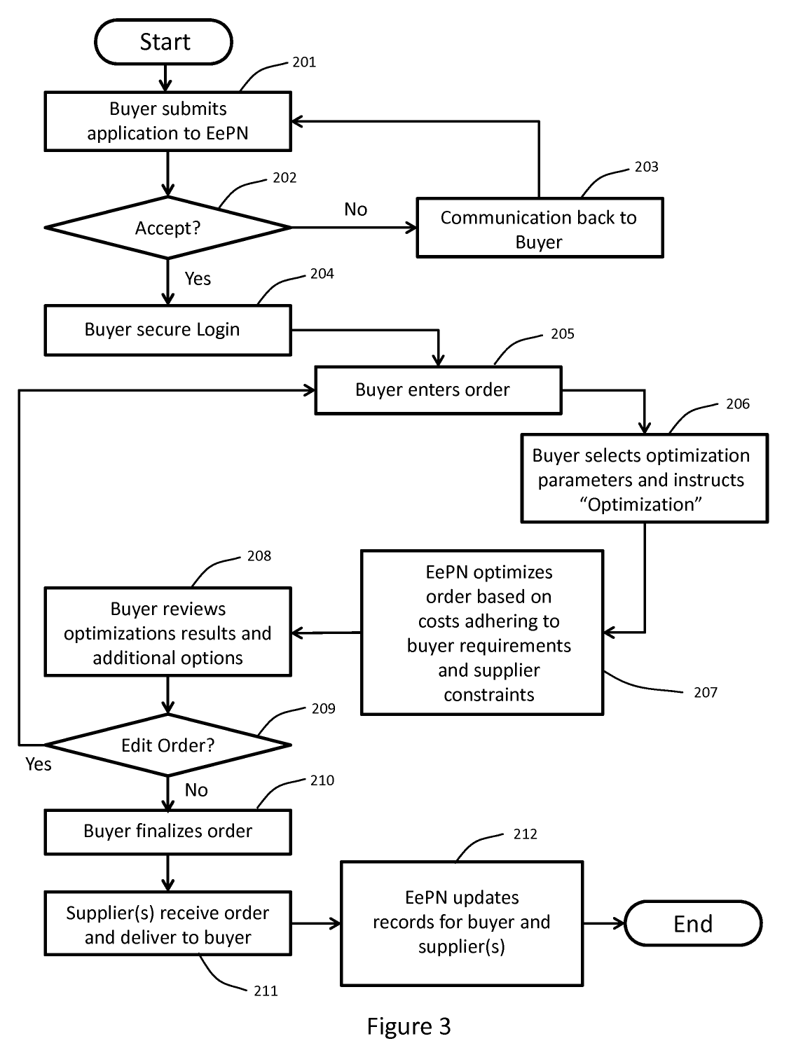

FIG. 3 shows a flowchart illustrating the steps a buyer may follow to execute and optimize an order through the EePN 100, according to an embodiment. In order to participate in the EePN 100, a buyer may need to be accepted by the EePN owner or operator. At step 201, the buyer submits an application to the EePN 100. At step 202, the EePN owner or operator reviews the buyer's application and decides whether to accept or reject the application. If the application is not accepted, or if it is incomplete, at step 203 the decision is communicated back to the buyer who has the choice to re-submit an application. If the application is accepted, the buyer proceeds to step 204 to login into the EePN 100 and gain access to the e-marketplace. At step 205, the buyer enters an order list that may include multiple items, specifying product attributes and quantities. It may be optional for the buyer to select particular suppliers or specific brands of products. At step 206, the buyer selects optimization parameters and criteria (e.g., delivery time, maximum number of deliveries, product and supplier ratings, restricted subset of suppliers) and instructs the EePN 100 to optimize the order. At step 207, using mathematical optimization algorithms, the EePN 100 optimizes the order minimizing costs, adhering to buyer requirements, optimization parameters, and supplier constraints (e.g., delivery time, volume discounts, buyer-supplier agreements, minimum order requirements). Optimized results including additional options (e.g., lower order costs obtained by relaxing certain optimization parameters) are sent back to the buyer for review. At step 208, the buyer reviews the optimized results and the additional options provided by the EePN 100. The buyer can edit the order at step 209. For example, the buyer may decide to add or delete products on the list or edit optimization parameters. If the buyer decides not to edit the procurement order, the buyer submits his order at step 210. At step 211, the selected supplier (or suppliers) receives the order for delivery to the buyer. Upon completion of delivery, at step 212, the EePN financial records are updated for both the buyer and the selected suppliers involved in the procurement transaction.

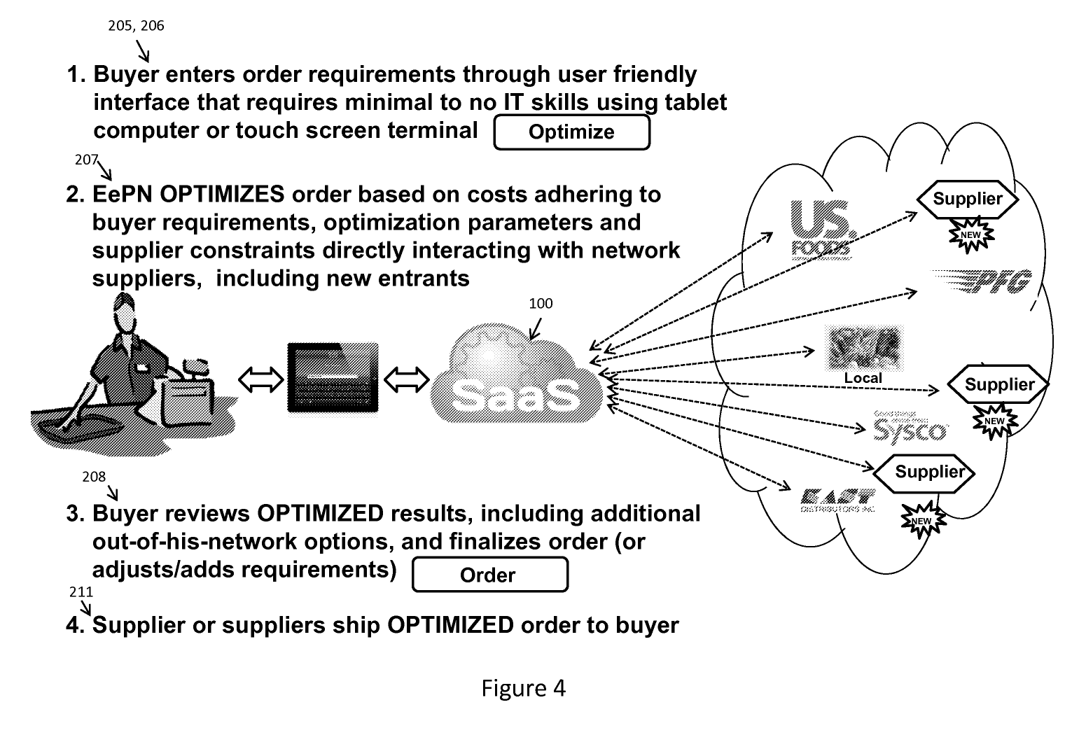

FIG. 4 summarizes, with continued reference to the steps of the flowchart of FIG. 3, an embodiment of an EePN 100 in the food distribution and procurement industry. The buyer may represent, in one example, a food service organization (e.g., a restaurant) ordering food supplies from food distributors. Since the majority of food service organizations may lack specialized IT skills, it may be particularly important for the buyer to have the ability to access the EePN through a user friendly interface that requires minimum to no IT skills using a tablet computer or touch screen terminal. A key benefit to the buyer is the ability to further minimize costs by linking to multiple suppliers, which are currently not part of the buyer's own supply chain (designated as new in the example provided in FIG. 4).

The Application Process: At step 201 of FIG. 3, the buyer submits an application for acceptance into the EePN 100. Similarly, suppliers (e.g., sellers and distributors) may also have to submit an application to the EePN 100 before access credentials are granted by the EePN owner or operator. This process may involve completion of an application form provided by the EePN 100. The buyer application form may solicit information that includes, but is not limited to, federal tax ID information, business location(s), size of business entity, current procurement suppliers used, preferential status with individual sellers (e.g., platinum, gold, silver), membership with purchasing programs, credit classification, and other attributes. The supplier application form may solicit information that includes, but is not limited to, federal tax ID, business location(s), distribution range, acceptance of credit terms, and other valuable information. Information from buyers and suppliers are used to establish parameters of the optimization model.

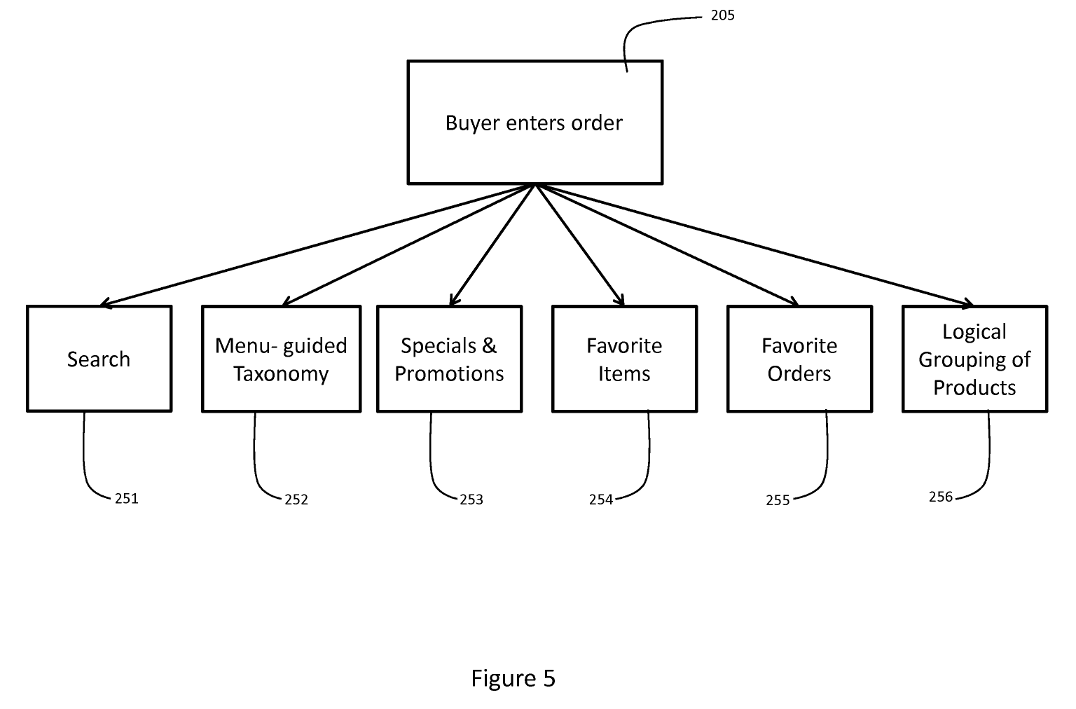

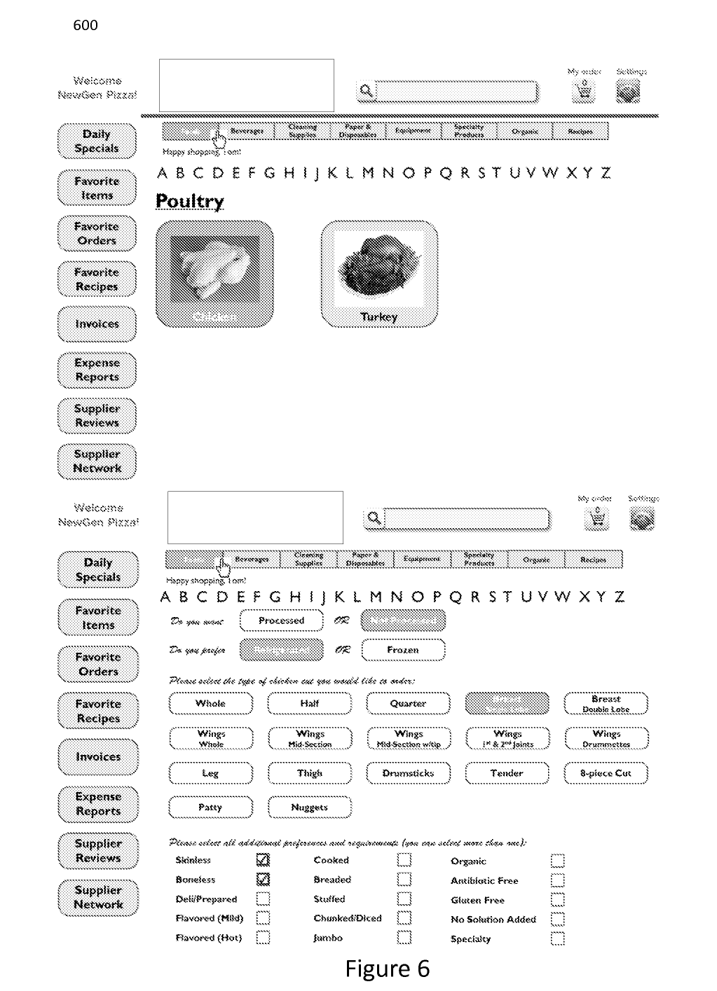

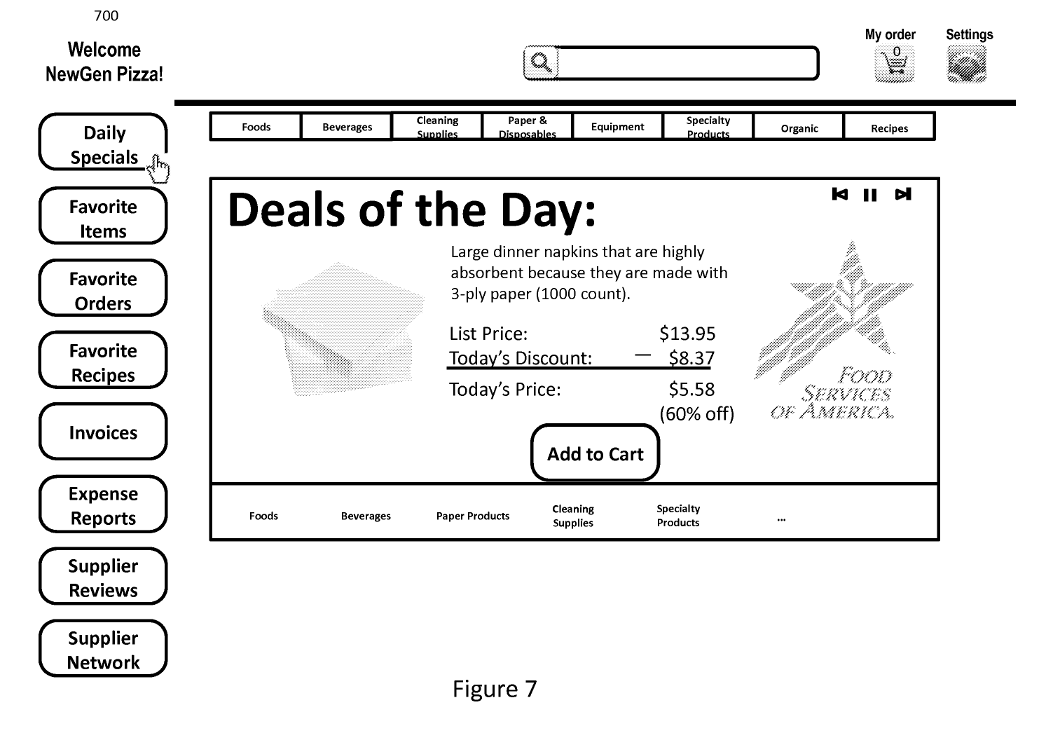

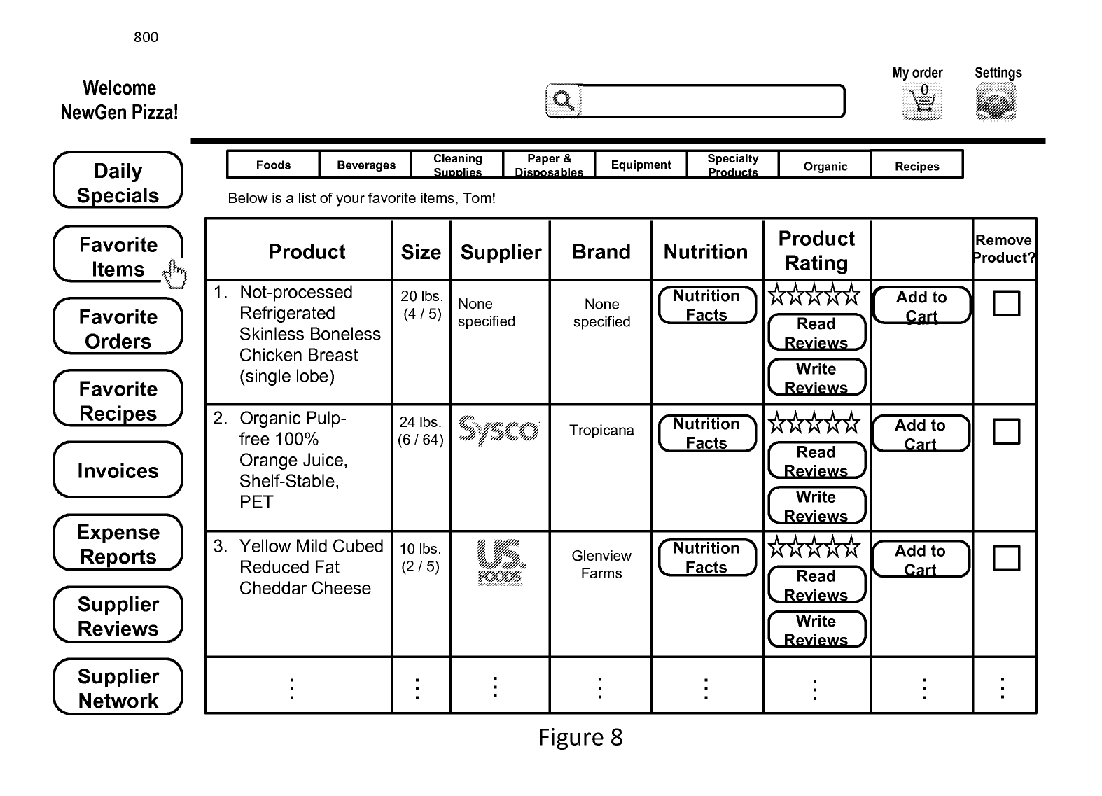

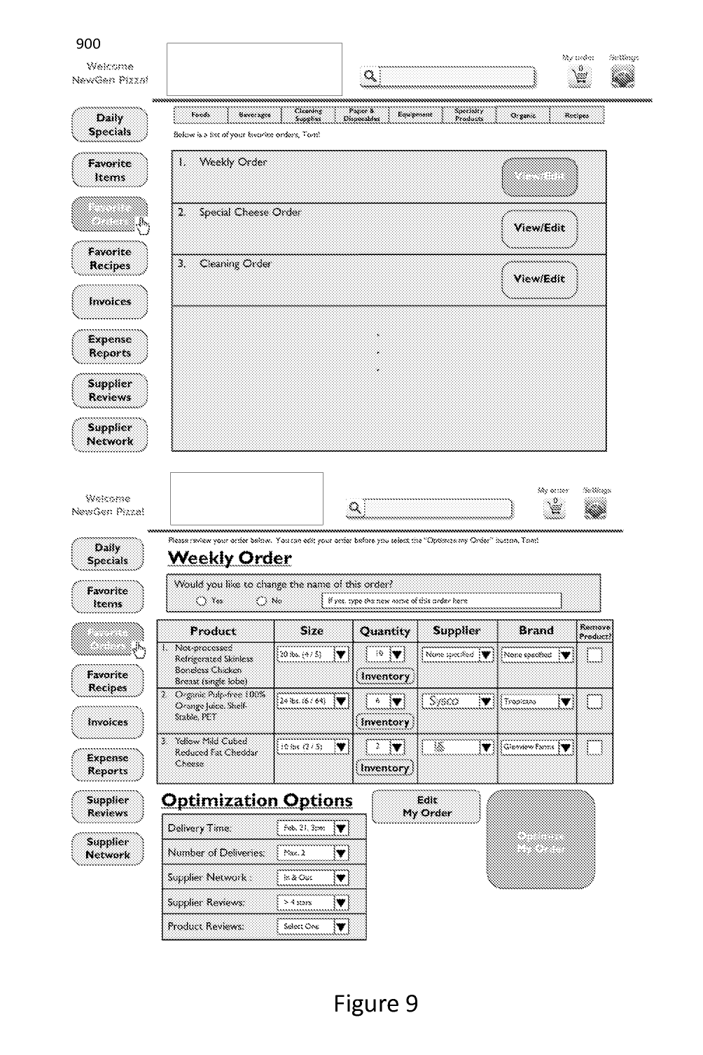

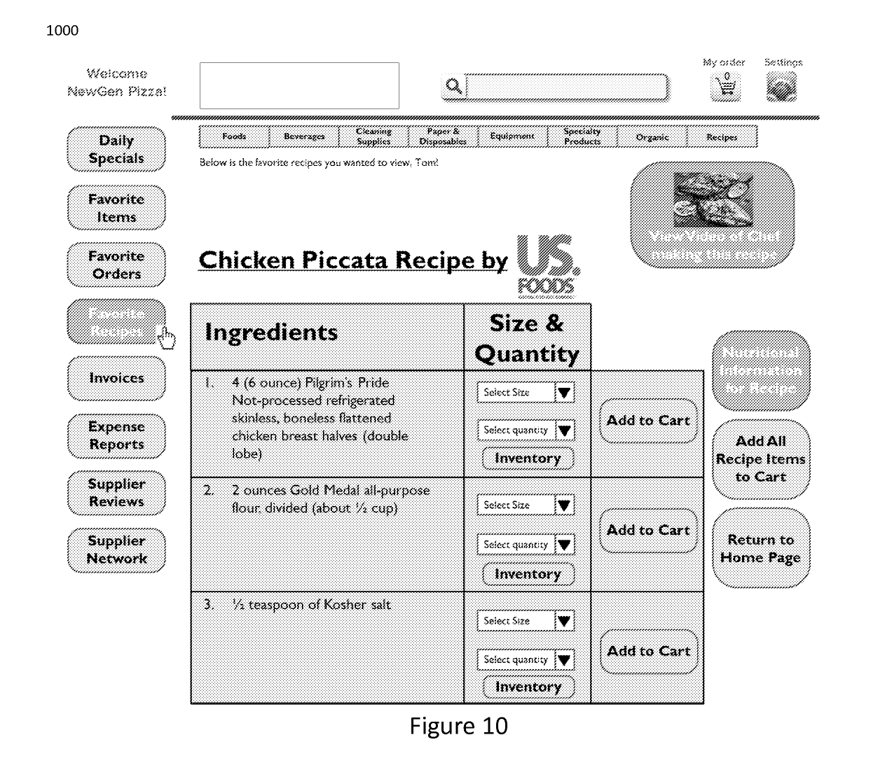

Formulation of Order List: At step 205 of FIG. 3, the buyer formulates the order list, which may be comprised of one or more items. There are multiple mechanisms that the buyer can use to formulate and enter his order. FIG. 5 illustrates an exemplary summary of ordering mechanisms 251, 252, 253, 254, 255, and 256 available through an EePN. A buyer can use any combination of mechanisms 251, 252, 253, 254, 255, and 256 to select items that comprise the same order (e.g., use a different mechanism for each item on the order list). In mechanism 251, the buyer searches for an item (or item category) by key words. In 252, the buyer selects an item through a series of menus that conform to an industry specific taxonomy. FIG. 6 illustrates this mechanism through a food procurement embodiment, showing an example where a food organization (the buyer) orders chicken based on selected product attributes (via screen 600 of a GUI). In mechanism 253, the buyer selects items from special promotions and specials offered by suppliers through the EePN 100. FIG. 7 illustrates ordering items through the specials and promotions method in an EePN embodiment in the food distribution industry (via screen 700 of a GUI). In mechanism 254, the buyer selects items from a favorite items list (or menu) taking into consideration previous purchases and orders. FIG. 8 illustrates ordering items through the favorite items method in an EePN embodiment in the food distribution industry (via screen 800 of a GUI). In selection method 255, the buyer selects from a list (or menu) of favorite orders, thus automatically selecting multiple items in the same order. FIG. 9 illustrates ordering items through the favorite orders method in an EePN embodiment in the food distribution industry (via screen 900 of a GUI). In 256, the buyer can select items to include in the order through industry specific logical groupings. For example, a restaurant owner can select a group of food items that constitute a specific food recipe. FIG. 10 illustrates ordering items through the logical grouping method in an EePN embodiment in the food distribution industry (via screen 1000 of a GUI). The present invention is not limited to the described ordering selection mechanisms and can accommodate additional variations as means of formulating order lists.

Buyer Optimization Parameters: At step 206 of FIG. 3, the buyer selects optimization parameters, i.e., criteria and requirements for acceptable transactions within an EePN 100. These criteria are used by the EePN optimization software 150 as constraints in the formulation of the problem of determining an optimized order for the buyer. Such optimization parameters may include (but are not limited to): (a) Delivery time, the time by when the buyer requires delivery of order items; (b) Maximum number of deliveries, the maximum number of deliveries the buyer will accept (for example, the buyer may want to restrict the number of deliveries in the same order, thus avoiding delivery bottlenecks and situations where each separate item on the list is delivered by a different supplier); (c) Selecting a restricted set of suppliers (the buyer can restrict procurement to his own designated set of trusted suppliers); (d) Supplier rating; the buyer can restrict optimization to suppliers that have achieved a certain rating (or above) from buyer reviews within the EePN 100; and (e) Product rating; the buyer can restrict optimization to only products that have achieved a minimum rating through reviews of buyers within the EePN 100.

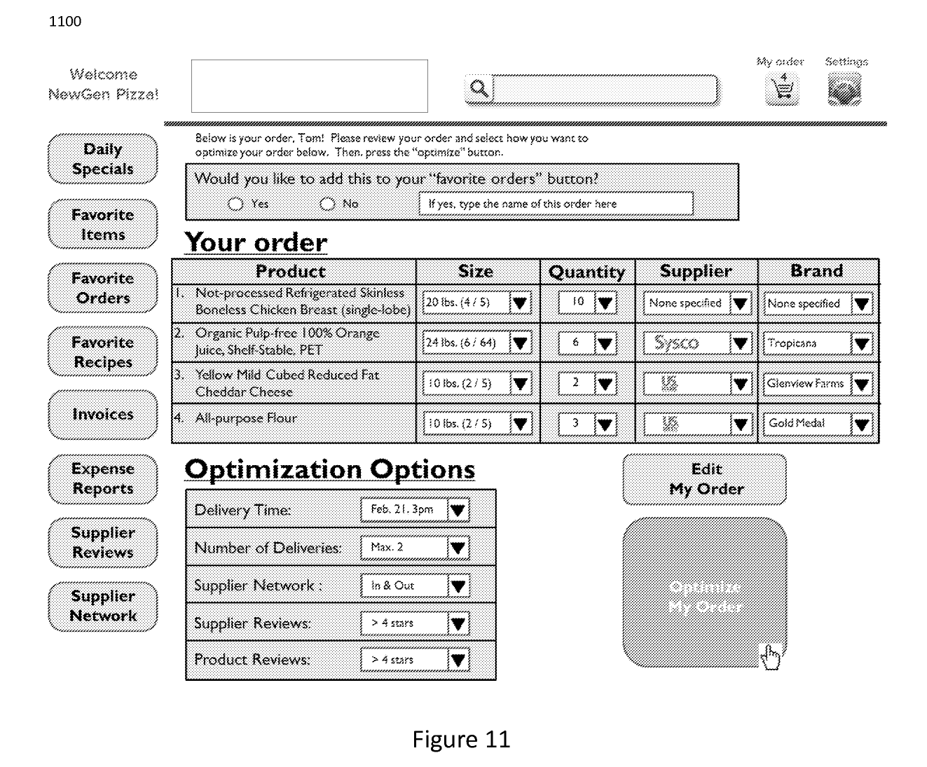

FIG. 11 (screen 1100) illustrates the selection of buyer optimization parameters (criteria) in an EePN embodiment in the food procurement industry. In the specific example, the buyer has indicated that a satisfactory transaction will have to be delivered by 3 pm on February 21, using a maximum of 2 deliveries (maximum of 2 different suppliers) and allowing for all suppliers in the EePN 100 (not just his own network) to participate in the transaction. However, the buyer wants only suppliers that have achieved above a 4-star rating and products that have above a 4-star rating based on reviews.

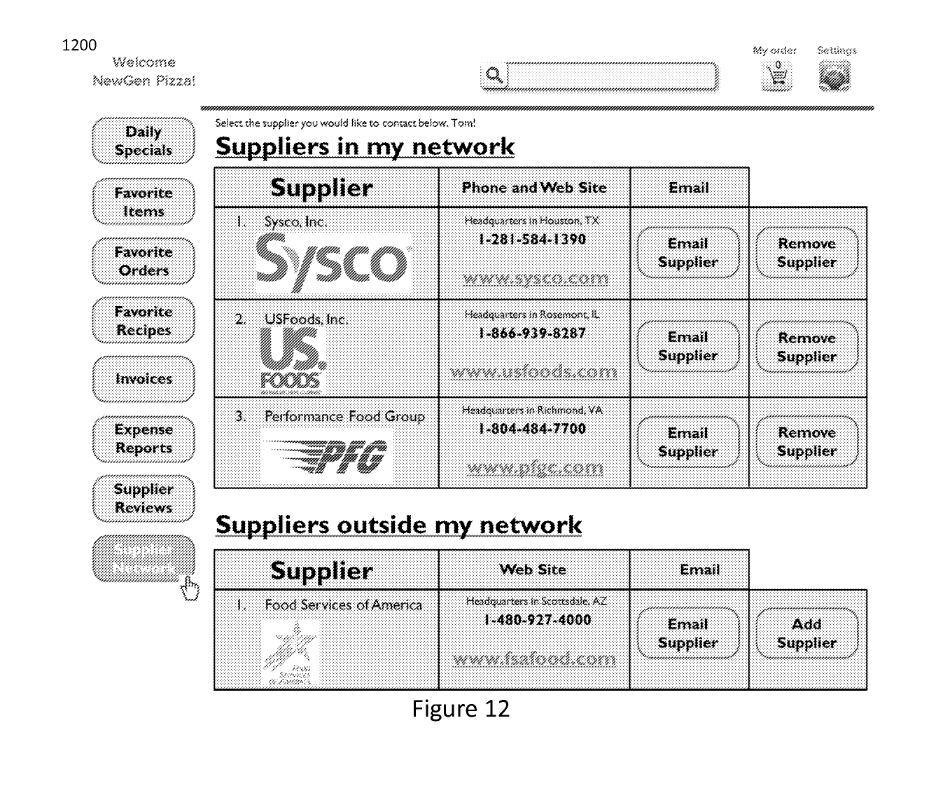

Developing Buyer Designated Supplier Networks: The EePN 100 allows individual buyers to restrict the e-marketplace and create their own network comprised of only their own designated suppliers, defined herein as the buyer “supplier network.” The buyers within the EePN 100 can define and modify (add or subtract) the “supplier network” by selecting a subset of all suppliers participating in the EePN 100. FIG. 12 illustrates an example of developing a buyer designated supplier network in the EePN embodiment in the food procurement industry (via screen 1200 of a GUI). In accordance with embodiments, the buyer designated “supplier network” allows the buyer to restrict optimization to only a select set of suppliers.

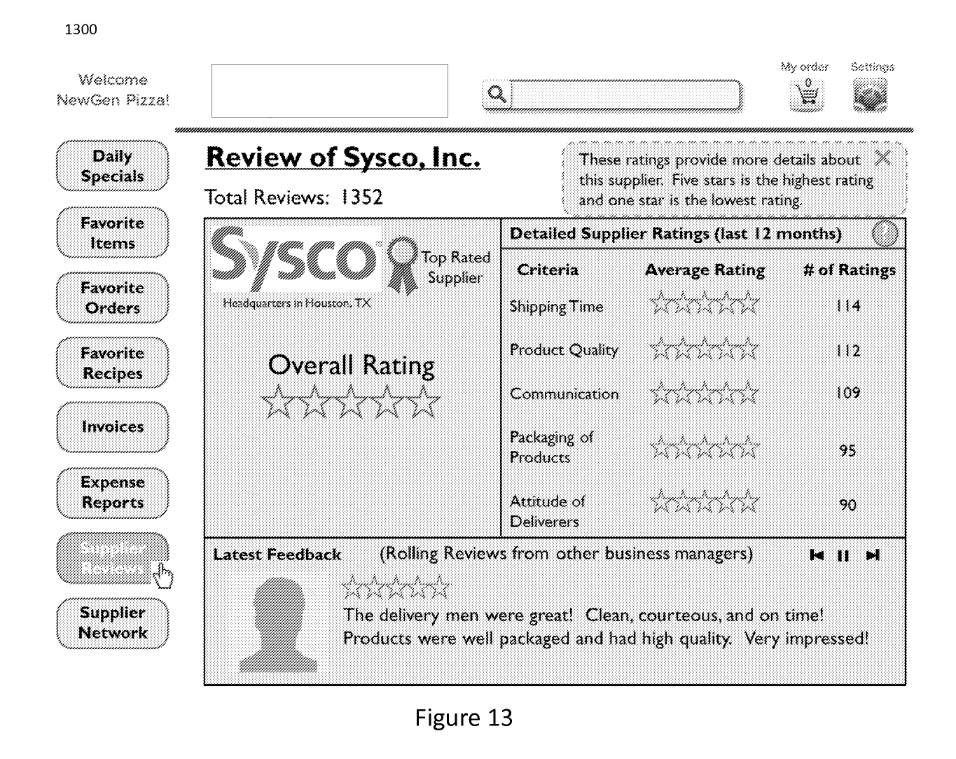

Ratings and Reviews: In accordance with embodiments, the EePN 100 provides buyers the ability to read and write reviews on both products and suppliers. The associated review ratings can be used as optimization parameters in step 206 of FIG. 3 in the formulation of the mathematical optimization model. FIG. 13 illustrates an example of a screen 1300 provided via a GUI, indicating a seller review in an EePN embodiment in the food procurement industry.

The Optimization Process: The EePN 100 deploys mathematical optimization algorithms that facilitate procurement between buyers and suppliers. At step 207 of FIG. 3, the EePN 100 optimizes the buyer order, minimizing costs adhering to buyer requirements, optimization parameters, and supplier constraints.

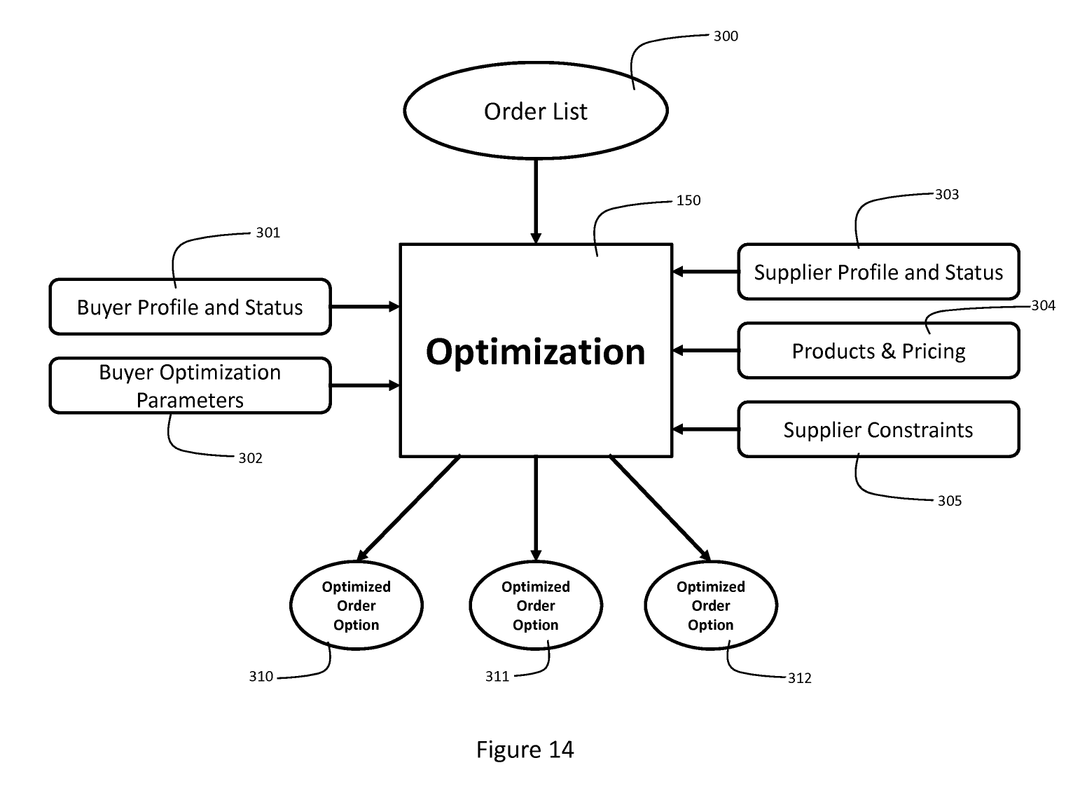

FIG. 14 illustrates an optimization process of the EePN 100, according to an embodiment. The embedded optimization software 150 uses one or more of the following sources of input to formulate the optimization problem: (a) An order list 300 formulated at step 205 of FIG. 3; (b) A buyer profile and status 301, which links the buyer upon login at step 204 of FIG. 3 with personal information obtained through the EePN application at step 201 of FIG. 3; (c) The buyer optimization parameters 302 obtained at step 206 of FIG. 3; (d) Profile and status of suppliers 303, including information from supplier applications to the EePN critical to formulating the optimization problem (e.g., distribution range, acceptance of credit terms, etc.); (e) Product and pricing information 304 that is obtained from suppliers either directly from their business systems through EDIs/APIs or manually through the use of GUIs (as explained with reference to FIG. 2); and (f) Supplier constraints 305 that may include delivery time constraints, minimum delivery levels, and other constraints.

FIG. 14 further illustrates that the output of the optimization software may include different optimized order options 310, 311, and 312 for the buyer to review at step 208 of FIG. 3. The first option 310 adheres to all of buyer and supplier requirements, parameters, and constraints. Additional options 311 and 312 are obtained by relaxing some of the buyer selected optimization parameters. For example, option 311 may loosen the buyer selected “maximum number of deliveries” constraint by increasing the total number of deliveries. Option 312 may relax the delivery time constraint by extending the required delivery time and date. The additional options 311 and 312 correspond to solving the same optimization problem after relaxing certain constraints. Fewer or more additional options may be determined and presented. For example, a particular buyer may indicate in the buyer profile that the buyer only wishes to be presented with the optimized order option corresponding to all of the buyer and supplier requirements, parameters, and constraints.

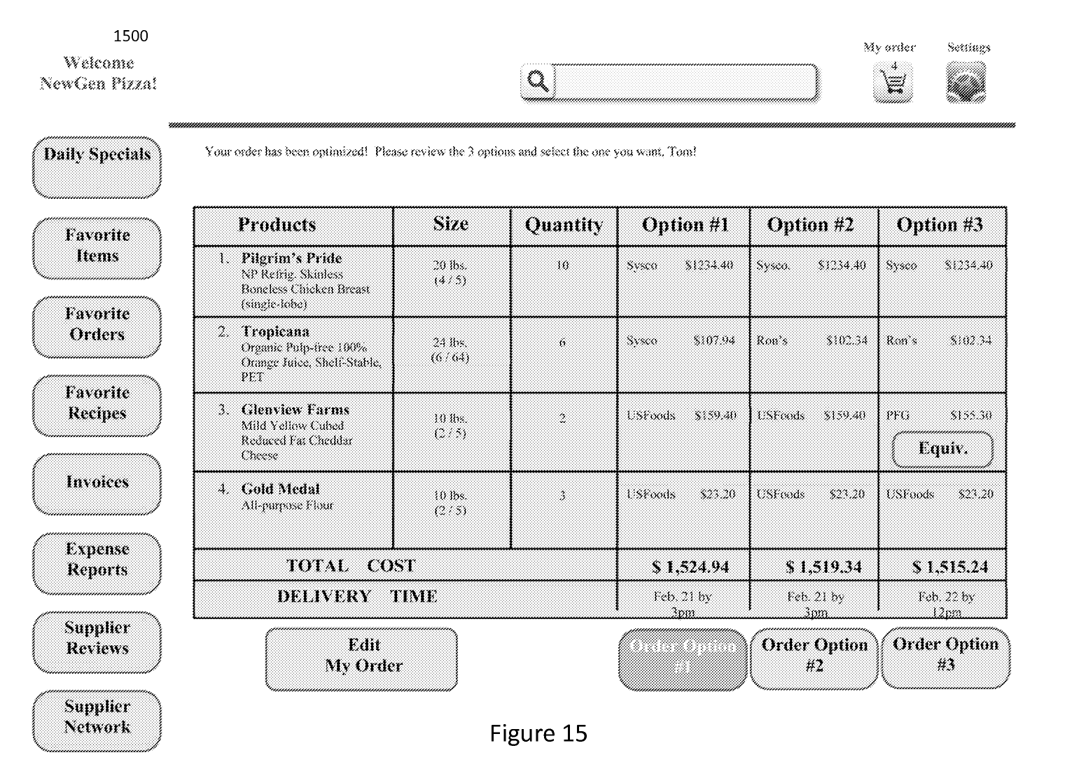

FIG. 15 illustrates, in screen 1500 of a GUI, optimized order options in an EePN embodiment in the food procurement industry. This example corresponds to the buyer order requirements and optimization parameters of FIG. 11. Option 1 is the optimized solution adhering to all buyer and supplier requirements and constraints. Option 2 is the optimized solution obtained by relaxing the maximum number of deliveries constraint by 1. Option 2 allows the buyer to order at lower cost if he is willing to relax his optimization requirements. Option 3 is the optimized solution obtained by relaxing the maximum number of deliveries constraint by 2 and also relaxing the delivery time constraint by a few hours. Option 3 allows the buyer to order at even a lower cost if he is willing to be more flexible with his requirements.

The formulated problem of determining the optimized order is an integer or mixed integer programming problem, a mathematical optimization problem in which some or all of the variables are restricted to be integers. Integer and mixed-integer mathematical programs are NP-hard (Non-deterministic Polynomial-time hard). In computational complexity theory, NP-hard problems is a class of problems that are, informally, “at least as hard as the hardest problems in NP.” The EePN optimization software 150 uses mathematical optimization techniques and algorithms that solve the problem to optimality using an exact optimization algorithm or to near-optimality using heuristics or guaranteed approximation schemes (such as primal, dual, or primal-dual approximation schemes).

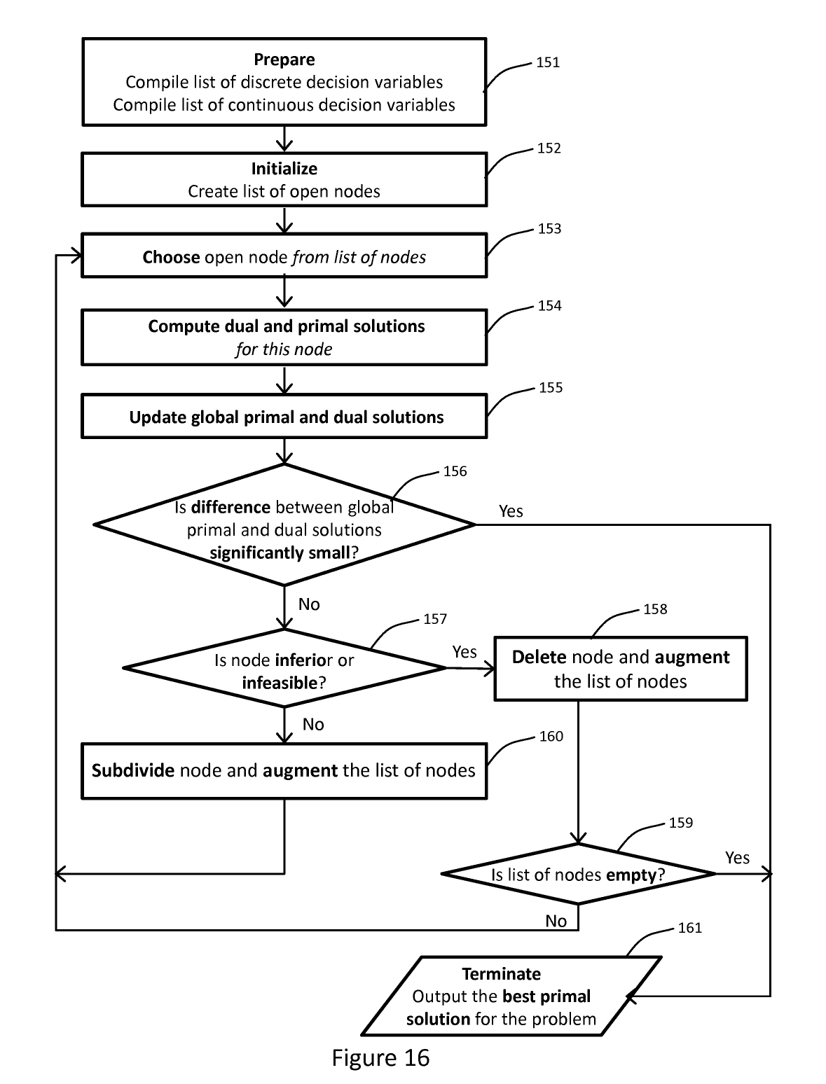

FIG. 16 is a flowchart illustrating the optimization algorithm employed to solve the integer or mixed-integer mathematical problem within the EePN 100, according to an embodiment. At step 151, the preparation step, a record of all possible discrete decision variables is compiled. Examples of such variables may include whether a product is to be procured from a specific supplier, procurement amounts from various sources that must be obtained in integer lots, and whether an order includes a specific volume discount that is offered by a supplier (i.e., buyer requirements, supplier constraints). A record of all possible continuous decision variables is also created. Examples of such variables may include procurement amounts for products available in continuous quantities, and volume discounts along with the corresponding dollars saved. At step 152, the initialization step, a list of sub-problems (i.e., open nodes) to the original problem is created that includes a single linear, semidefinite, lagrangian or other suitable relaxation of the discrete problem. At step 153, an iterative process is started, where a problem (node) is chosen from the list of open nodes. At step 154, dual and primal solutions are calculated for the selected open node of step 153. In mathematical optimization theory, duality means that optimization problems may be viewed from either of two perspectives, the primal problem or the dual problem (the duality principle). The solution to the dual problem provides a lower bound to the solution of the primal (minimization) problem. However, the optimal values of the primal and dual problems need not be equal. A dual bound (solution) is obtained through solution of the relaxation. For the same problem (node), a primal solution is obtained through rounding, rounding-and-diving, or other primal feasibility search heuristic or guaranteed approximation scheme. At step 155, the primal and dual solutions of this node are used to update the best available primal and best possible dual solutions known for the original problem. At step 156, the difference between values of the best primal and best possible dual solutions is compared to a pre-determined tolerance level. If the difference is sufficiently small, the algorithm is terminated, and at step 161, the best primal solution for the problem is recorded in terms of values for all discrete and continuous decision variables. If not, at step 157, the algorithm examines whether the node's dual solution is inferior in comparison to the best known primal solution for the problem or if the node is infeasible and does not satisfy problem constraints (e.g., product demands). If the node is found to be either inferior or infeasible, at step 158, the node is deleted and the list of open nodes is augmented. At step 159, the current list of nodes is examined. If the list becomes empty, the algorithm is again terminated at step 161. If the list is not empty, the algorithm returns to step 153 and a new node (problem) is selected from the list of open nodes. If at step 157, the current selected node is found to be neither inferior nor infeasible, the algorithm proceeds to step 160, where the current problem (node) is partitioned into sub-problems (nodes) and the current problem (node) is replaced by these new sub-problems (nodes) in the list of open problems (nodes) returning to step 153.

The original problem to be solved by the optimization algorithm is how to optimize the buyer order taking into account the variables of buyer requirements, optimization parameters, and supplier constraints. The sub-problems refer to the original problem with some of the constraints removed (e.g., supplier requirements, cost discounts, delivery date, etc.). These requirements are gradually enforced in the context of the algorithm.

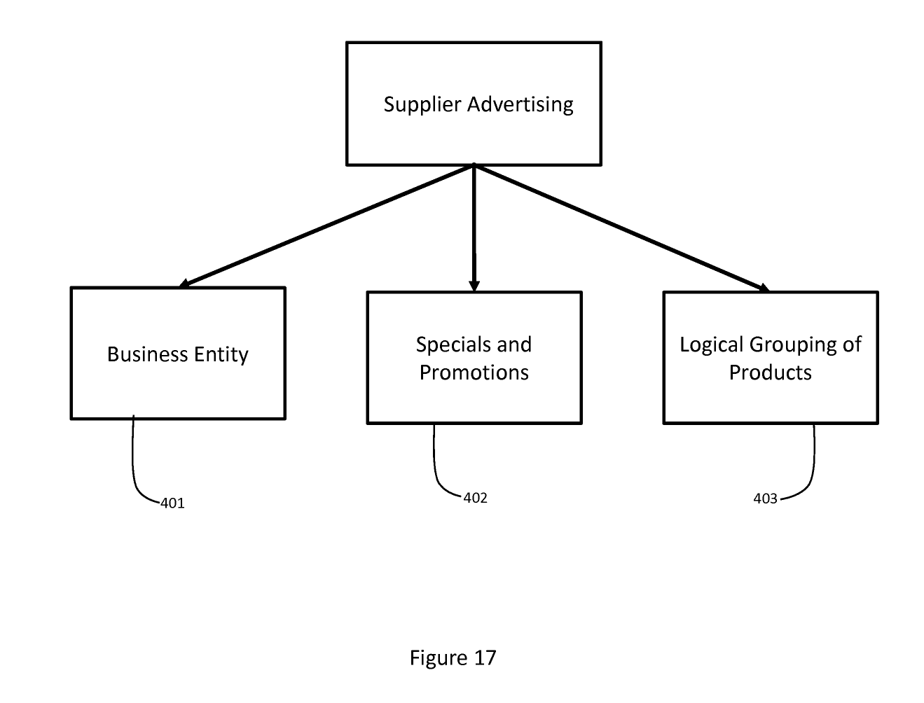

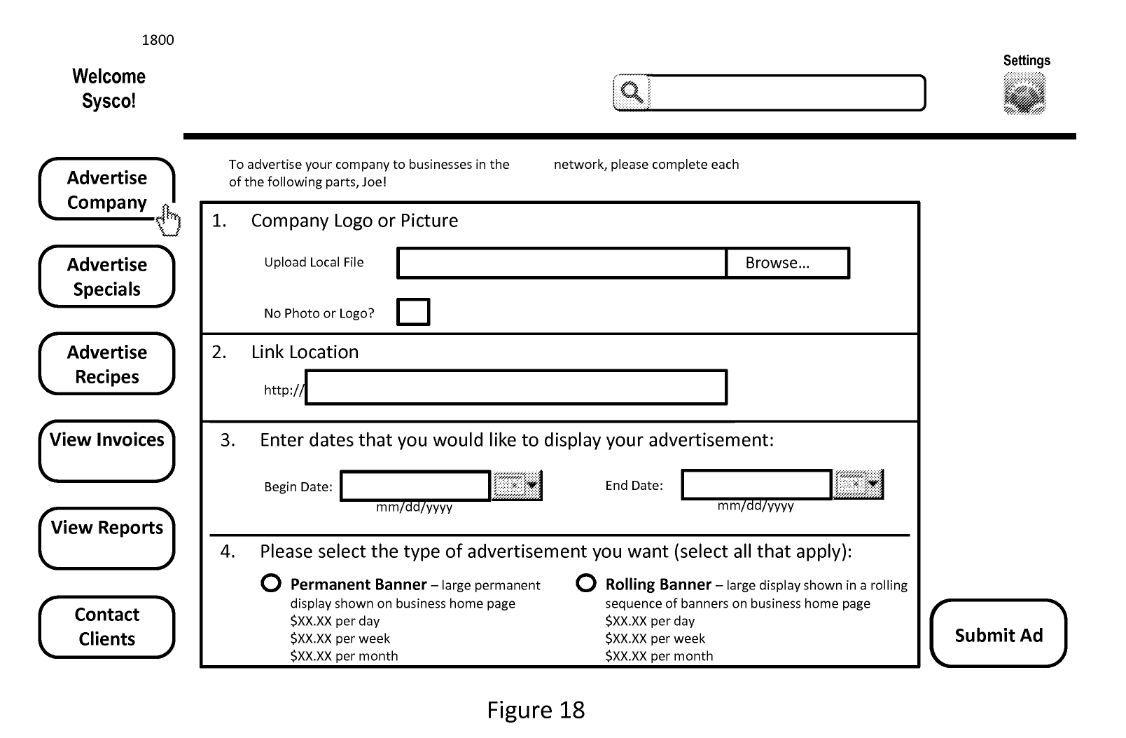

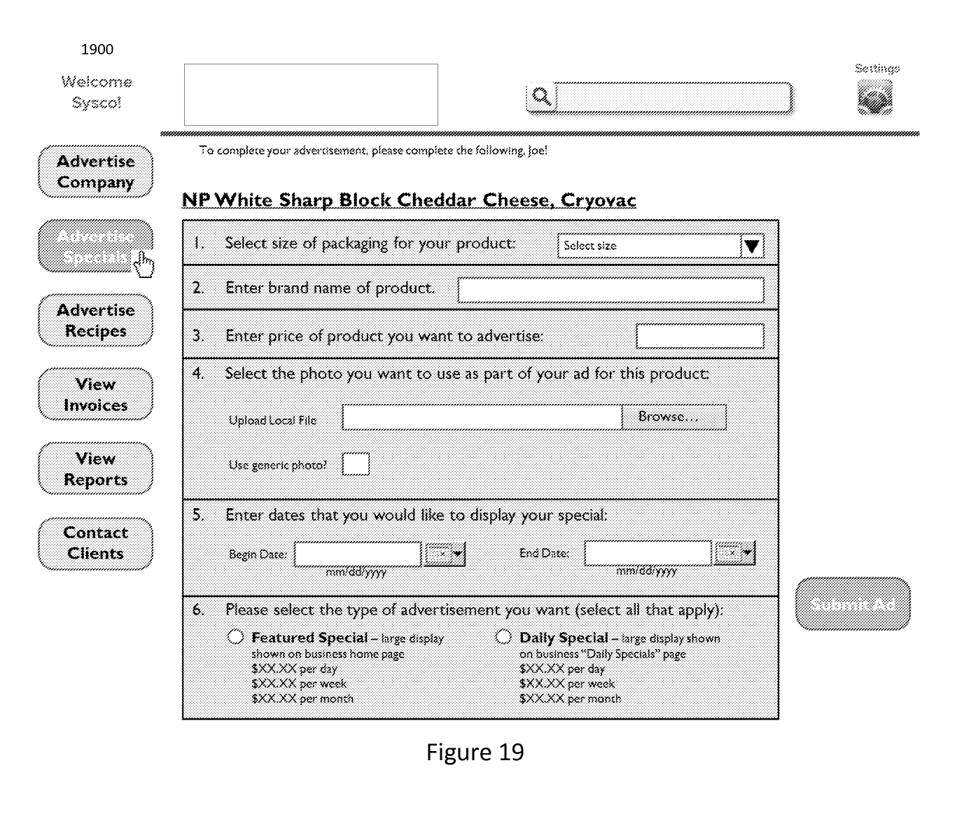

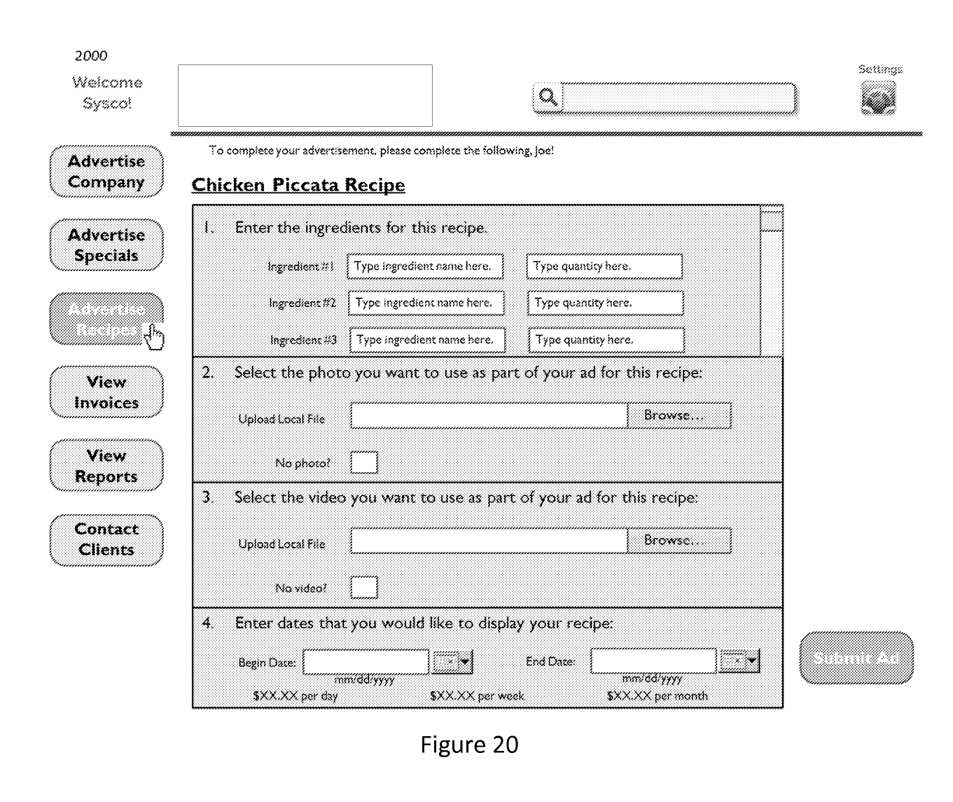

Supplier Advertising: The EePN 100, according to embodiments provided herein, provides efficiencies not only to buyers but also to suppliers. Targeted advertising is one mechanism the EePN 100 employs to enable suppliers to expand their customer base, sales, and channels. FIG. 17 shows three efficient advertising mechanisms 401, 402, and 403 available through the EePN 100. A supplier can use any combination of such mechanisms 401, 402, and 403 through the EePN 100. In the first mechanism 401, suppliers can advertise their whole business entity (i.e., their company), allowing the buyers to access their main company internet site by clicking, for example, their company logo and banner. A supplier can submit company information to the EePN 100 through a GUI provided by the EePN. FIG. 18 illustrates an example of a GUI 1800 for submitting company advertisement in an EePN embodiment in the food distribution industry. In mechanism 402 of FIG. 17, a supplier can advertise specials and promotions, allowing the buyers to directly include these items on the order list. The sequence that these specials and promotions are shown to the individual buyer may depend on the individual buyer's profile, status, and order history. For example, an owner of an Italian restaurant may first see specials and promotions pertinent to an Italian cuisine menu. Furthermore, specific items may be sorted based on previous buyer purchase history. FIG. 19 illustrates an example of a GUI 1900 for submitting specials and promotions in an EePN embodiment in the food distribution industry. In mechanism 403 of FIG. 17, a supplier can advertise a collection of products that are logically grouped together. For example, food distributors may advertise whole recipes to restaurants catering to specific cuisines. Through this mechanism, suppliers can enhance sales and entice new customers. FIG. 20 illustrates an example of a GUI 2000 for submitting recipes in an EePN embodiment in the food distribution industry.

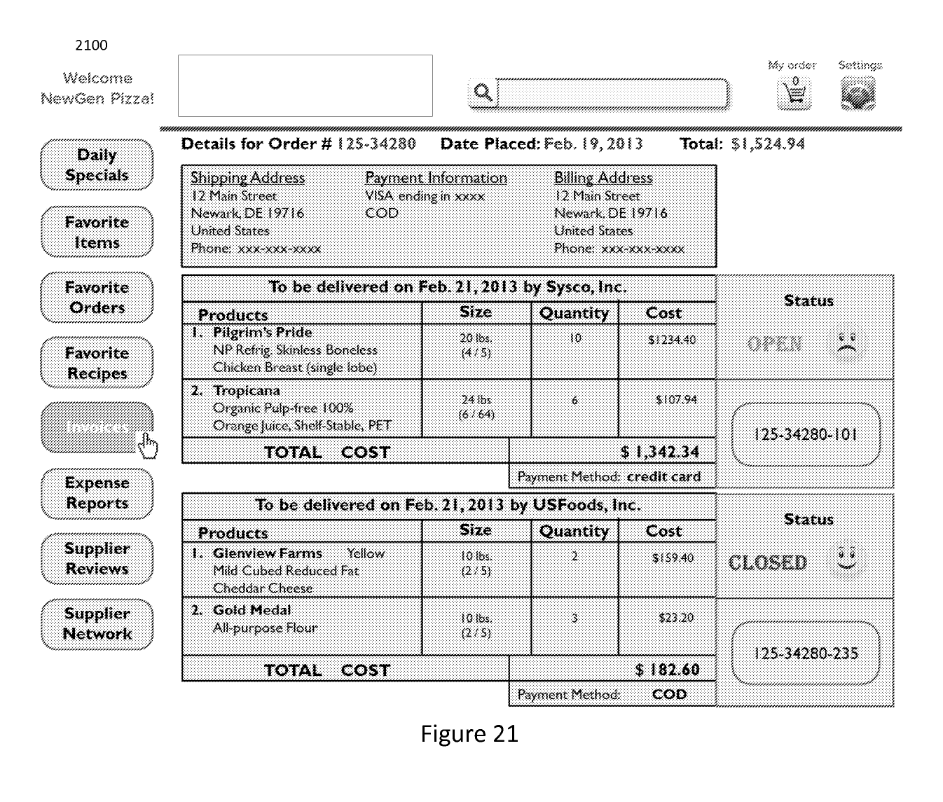

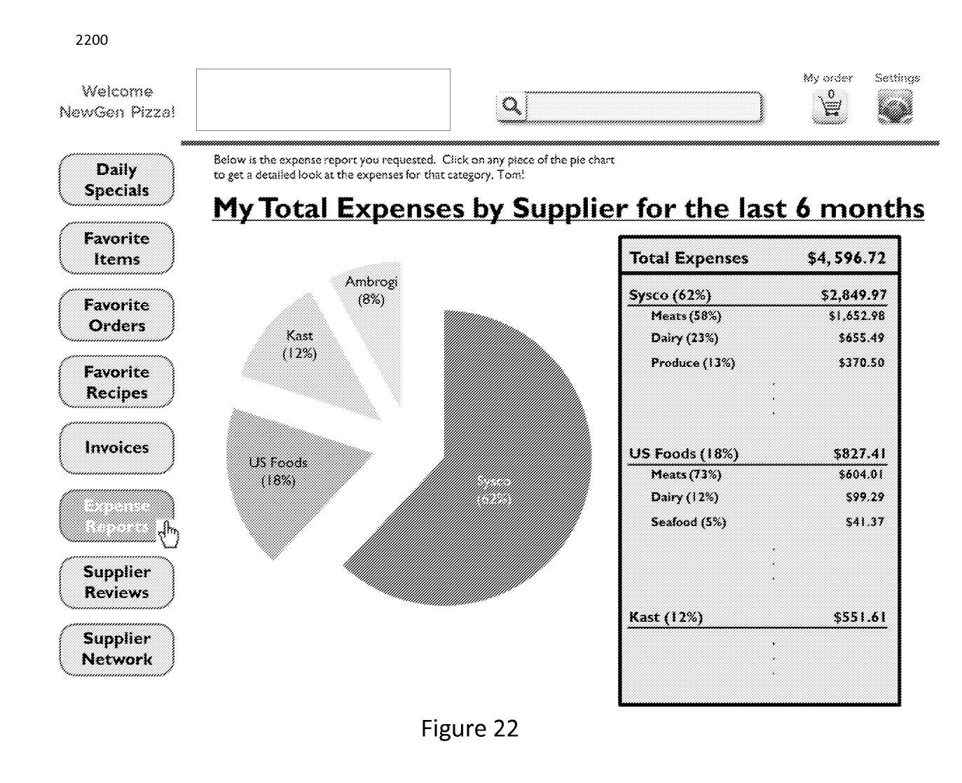

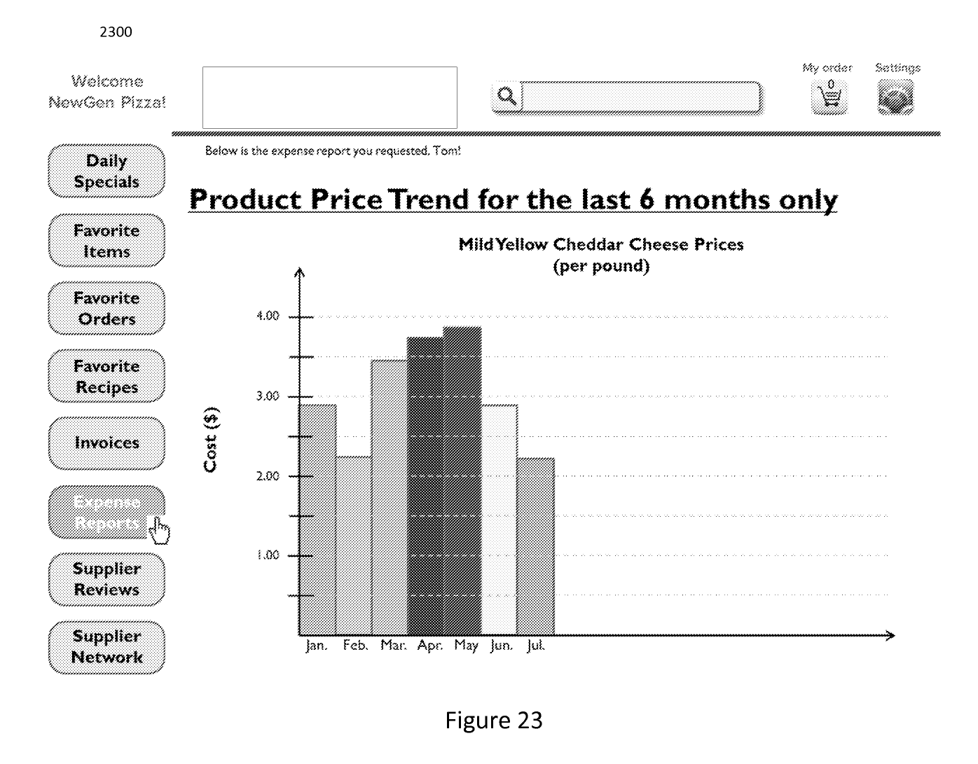

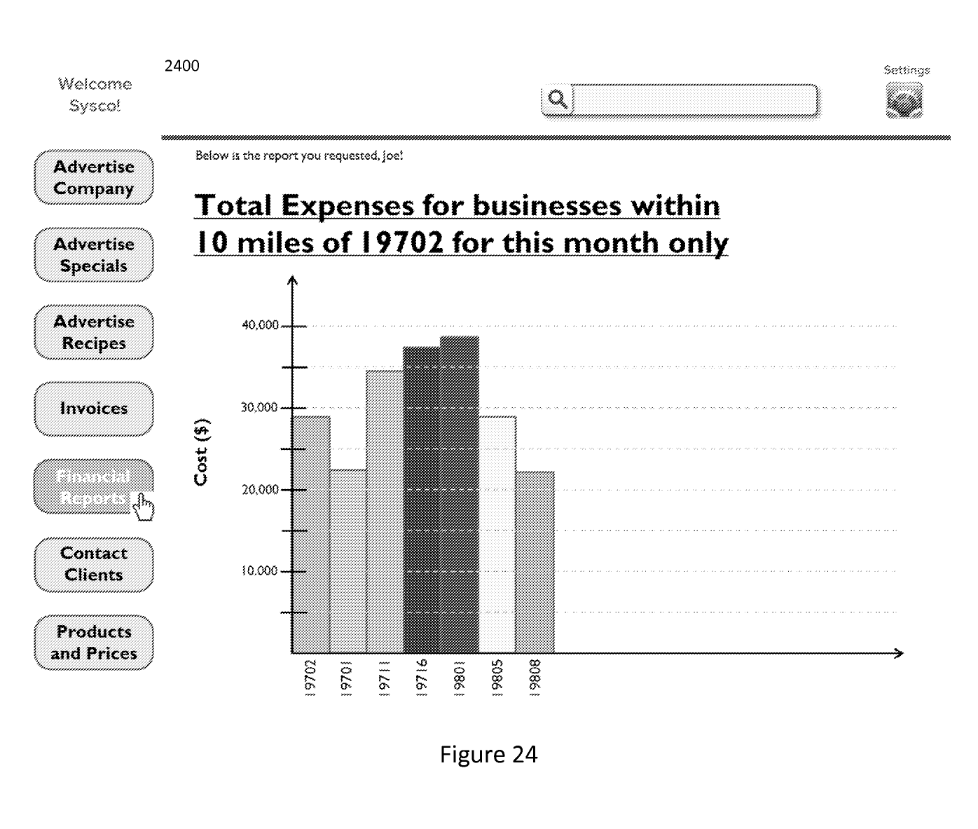

Financial Reports: The EePN 100 can provide additional efficiencies to both buyers and suppliers through management of order history, invoice history, business expenses, product price comparisons, territory sales, and other financial instruments. For example, the EePN 100 can provide a buyer the ability to view open and closed orders and invoices, expenses by supplier, product-price comparisons over a specified period of time, and other reports. FIG. 21, in screenshot 2100, illustrates an example of buyer invoices in an EePN embodiment in the food procurement industry. FIG. 22, in screenshot 2200, illustrates an example of expenses by supplier report in an EePN embodiment in the food procurement industry. FIG. 23, in screenshot 2300, illustrates an example of a product-price comparison report in an EePN embodiment in the food procurement industry. Similarly, the EePN 100 will enable sellers to see open and closed orders and invoices, expense reports by buyer, territory sales reports (e.g., by zip code), and other reports. FIG. 24, in screenshot 2400, illustrates an example of a sales territory report in an EePN embodiment in the food procurement industry.

Communication: An EePN can provide communication information and means of electronic communication (e.g., e-mail) between buyers and suppliers.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A system for conducting electronic commerce among a plurality of buyers and a plurality of suppliers, the system comprising:
a network configured to interconnect the plurality of buyers and the plurality of suppliers, the network comprising one or more servers configured to:
receive input from one of the plurality of buyers relating to a transaction;
optimize the transaction among the one of the plurality of buyers and one or more of the plurality of suppliers according to one or more predefined buyer and supplier attributes, requirements, and constraints, wherein the optimization process comprises defining the transaction as a dual problem and solving a sequence of dual problems corresponding to sub-problems of the transaction, the solution to which leads to a solution to the transaction; and
convey results of the optimized transaction to the one of the plurality of buyers and the one or more of the plurality of suppliers involved in the optimized transaction.

2. The system of claim 1, wherein one or more of (i) the input relating to the transaction; (ii) the one or more predefined buyer and supplier attributes, requirements, and constraints; (iii) results of the optimized transaction; and (iv) information relating to the electronic commerce system are provided through graphical user interfaces on devices accessible to the plurality of buyers and the plurality of suppliers.

3. The system of claim 1, wherein one or more of (i) the input relating to the transaction; (ii) the one or more predefined buyer and supplier attributes, requirements, and constraints; (iii) results of the optimized transaction; and (iv) information relating to the electronic commerce system are provided through interfaces that link to buyer and supplier business systems and programs.

4. The system of claim 1, wherein the network operates in a cloud computing environment.

5. The system of claim 1, further comprising:
one or more databases for storing data relating to one or more of (i) the plurality of buyers, (ii) the plurality of suppliers, (iii) products, (iv) transactions, (v) financial data comprising one or more of historical financial information, current financial information, historical product pricing, current product pricing, previous transactions, and pending transactions;
wherein the data contained on the one or more databases is accessible by the one or more servers; and
wherein the one or more servers are further configured to convey the data relating to relevant ones of the plurality of buyers and the plurality of suppliers.

6. The system of claim 1, wherein the one or more servers are further configured to implement an application process to the plurality of buyers and the plurality of suppliers, the application process comprising submission of information relating to a respective one of the plurality of buyers or the plurality of suppliers.

7. The system of claim 1, wherein access privileges to the network are controlled by at least one of: (i) an operator of the network; and (ii) through validation of participant credentials and attributes.

8. The system of claim 1, wherein the one or more predefined buyer attributes, requirements, and constraints define one or more of: (i) one or more preferred brands; (ii) one or more preferred suppliers; (iii) a preferred delivery timeframe; (iv) a maximum number of deliveries; (v) a minimum supplier rating; and (vi) a minimum product rating.

9. The system of claim 1, wherein the transaction is comprised of one or more items, products, and services.

10. The system of claim 9, wherein each of the one or more items, products, and services for the transaction is identified and selected through one or more of: (i) an electronic search based on attributes of a respective one of the item, product, and service; (ii) a menu guided taxonomy; (iii) an advertised specials and promotions list compiled from input by participating ones of the plurality of suppliers; (iv) a favorite items list provided by the buyer or derived based on previous purchase history of the buyer; (v) a favorite orders list derived from previous purchases by the buyer; and (vi) industry specific logical groupings of items, products, and services.

11. The system of claim 9, wherein quantities of each of the one or more items, products, and services for the transaction are selected through one or more of: (i) a graphical user interface on one or more devices used by the buyer; (ii) interfaces that link to buyer business systems and programs; and (iii) inventory assisted computer code that executes par inventory levels.

12. The system of claim 1, wherein the optimized transaction comprises a minimum cost adhering to the one or more predefined buyer attributes, requirements and constraints.

13. The system of claim 1, wherein the one or more predefined buyer and supplier attributes, requirements, and constraints are adjustable.

14. The system of claim 1, wherein the plurality of suppliers provide updated financial and product information as part of the supplier attributes, requirements, and constraints.

15. The system of claim 1, wherein the optimized transaction comprises a plurality of optional transactions;
wherein a first one of the plurality of optional transactions comprises a minimum cost adhering to the one or more predefined buyer attributes, requirements, and constraints; and
wherein other of the plurality of optional transactions are obtained by relaxing one or more of the predefined buyer attributes, requirements, and constraints.

16. The system of claim 15, wherein the one or more servers are further configured to:
receive an adjustment of at least one of the one or more predefined buyer attributes, requirements, and constraints by the one of the plurality of buyers;
determine the plurality of optional transactions according to the adjustment; and
convey information relating to the plurality of optional transactions.

17. The system of claim 1, wherein the one or more servers are further configured to enable electronic communication between the plurality of buyers and the plurality of suppliers via electronic mail facilities within the network or stored on a third party system.

18. The system of claim 1, wherein the system for conducting electronic commerce is for procurement of food and restaurant supplies.

19. The system of claim 1, wherein optimizing the transaction further takes into account requirements and constraints pertinent to a particular industry to which the electronic commerce is directed.

20. A computer-implemented method for conducting electronic commerce among a plurality of buyers and a plurality of suppliers interconnected to one another through a network comprised of one or more servers, the method comprising:
formulating a mathematical optimization problem for a transaction among one of the plurality of buyers and one or more of the plurality of suppliers, the mathematical optimization problem comprised of an objective function and one or more variables comprised of one or more predefined buyer and supplier attributes, requirements and constraints;
executing transaction optimization code that optimizes the objective function adhering to the one or more predefined buyer and supplier attributes, requirements, and constraints, wherein results of the executed transaction optimization code yield one or more combinations of the one of the plurality of buyers and one or more of the plurality of suppliers; and
conveying the optimized transaction results to each participant involved in the transaction.

21. The method of claim 20, wherein the objective function comprises a cost minimization objective.

22. The method of claim 20, wherein the mathematical problem is formulated as an integer or mixed-integer mathematical problem.

23. The method of claim 20, wherein the transaction optimization code solves the problem to true optimality using mathematical optimization techniques.

24. The method of claim 20, wherein the transaction optimization code solves the problem to near optimality using one or more of mathematical optimization techniques, heuristics, and approximation schemes.
